(19) United States
(12) Patent Application Publication
(10) Pub. No.: US 2010/0085158 A1
(43) Pub. Date: Apr. 8, 2010

(54) METHOD OF TRANSMITTING DATA, ELECTRONIC DEVICE AND TRANSPONDER

(75) Inventor: Franz Amtmann, Graz (AT)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP, B.V., Eindhoven (NL)

(21) Appl. No.: 12/522,207

(22) PCT Filed: Dec. 18, 2007
(86) PCT No.: PCT/IB2007/055200

§ 371 Date: Jul. 6, 2009

(30) Foreign Application Priority Data
Jan. 9, 2007 (EP) 07000342.1

(51) Int. Cl. H04Q 5/22

(52) U.S. Cl. 340/10.1

(57) ABSTRACT

In a method of transmitting data, a low or high frequency transponder (4) receives a first data stream (12) via a field emitted by a reader (1), decodes the first data stream (12) utilizing an internal clock signal (13) generated by the transponder (4), and generates and emits a second data stream (14) to the reader (1) in response to the first data stream (12). The second data stream (14) is generated and transmitted utilizing a clock information transmitted via the field emitted by the reader (1).

### FIELD OF THE INVENTION

The invention relates to a method of transmitting data, to an electronic device, and to a transponder.

### BACKGROUND OF THE INVENTION

Transponders, which are also referred to as tags or labels, are well known in the art and are designed to communicate with a reader, which is also known as a base station. Usually, the transponder comprises an electronic circuit, for instance, an integrated circuit and an antenna to capture signals sent by the reader. Then, the electronic circuit processes the signals captured by the antenna and may generate a response signal for the reader.

Conventional low and high frequency transponder reader systems are designed such that the information transfer between the reader and the transponder and between the transponder and the reader is based on a synchronous data transfer, meaning that the electronic circuit of the transponder and thus the signal processing carried out by the electronic circuit is based on a clock information carried by the field emitted by the reader.

Particularly, the signal processing carried out for both, the processing of the received signal and the generation of the response signal is based on this clock information of the reader field. While the synchronous transfer mode allows communication between the transponder and the reader over a relative long distance, it is characterized by a relative high power consumption of the transponder.

Published U.S. application for patent No. 2005/0212661 A1 moreover discloses a method for data transmission in RFID systems wherein the transponder can transmit signals to the reader either in a synchronous or an asynchronous data transfer mode.

### OBJECT AND SUMMARY OF THE INVENTION

It is an object of the present invention to provide a method of transmitting data between a reader and a transponder, which method is likewise reliable and more power efficient.

A further object of the invention is to provide an electronic device for a transponder and a transponder which allow a reliable and power efficient communication with a reader.

The object is achieved in accordance with the invention by means of a method of transmitting data, comprising the steps of:

receiving a first data stream at a low or high frequency transponder via a field emitted by a reader;

processing the first data stream at the transponder utilizing an internal clock signal generated by the transponder; and in response to the first data stream, generating a second data stream at and emitting from the transponder to the reader, wherein the second data stream is generated and transmitted utilizing a clock information transmitted via the field emitted by the reader.

The inventive method is directed to an operation of a low or high frequency transponder, which may communicate with a reader utilizing carrier frequencies less than 30 MHz, preferably around 125 kHz or around 13.56 MHz.

According to the inventive method, data streams sent to the transponder are decoded utilizing the internal clock signal. This mode of operation is also known as an asynchronous transfer mode. When sending data streams from the transponder to the reader, the clock information from the field emitted by the transponder is utilized for clocking this data stream. This mode of operation is also known as a synchronous transfer mode.

Thus, the transponder does only utilize the clock information carried by the field emitted by the reader, i.e. the clock information generated by the reader, for generating and transmitting the second data stream. On the other hand, the transponder clocks the first data stream, i.e. an incoming data stream, solely on its own internal clock signal.

The asynchronous transfer mode has the advantage to be relatively power efficient, however is inferior compared to the synchronous transfer mode in terms of timing. On the other hand, the synchronous transfer mode has an advantage in terms of timing, but is less power efficient.

Since timing is not as crucial when the transponder receives and decodes signals as it is when generating and sending signals, the inventive method is more power efficient compared to conventional methods, while being at least almost as reliable as conventional methods based on synchronous transfer modes for sending and receiving data.

The first data stream may particularly be modulated utilizing an Amplitude Shift Keying (ASK) method and the second data stream may particularly be modulated utilizing a load modulation method or backscattering signaling.

In one embodiment of the inventive method, information of a third data stream sent by the reader is written to a memory of the transponder utilizing the internal clock signal. Timing is relatively uncritical when writing data to the transponder memory. So, an asynchronous transfer mode can be used for this operation to save power.

The object is also achieved in accordance with the invention by means of an electronic device for a low or high frequency transponder, comprising: an internal clock signal generator for generating an internal clock signal;

a memory for storing data; and

a signal processing device to decode an incoming data stream utilizing the internal clock signal, to generate an outgoing data stream in response to the incoming data stream by reading out the data from the memory, and to clock the outgoing data stream utilizing a clock information contained in a field emitted by a reader.

The object is also achieved in accordance with the invention by means of a low or high frequency transponder comprising the inventive electronic device and an antenna connected to the electronic device, configured to capture the incoming data stream when transmitted via the field emitted by the reader, and to transmit the outgoing data stream.

The inventive electronic device, which may be an integrated circuit, and the inventive transponder comprising the inventive electronic device are thus designed to be used to carry out the inventive method. Since incoming data streams are decoded utilizing the internal clock signal and outgoing data streams are generated and transmitted utilizing the clock information from the reader, the inventive transponder is more power efficient than and at least as reliable as conventional low or high frequency transponders in terms of timing, which conventional transponders clock all signals utilizing a clock information generated by the reader.

The electronic device may be configured to store data on the memory in response to a further incoming signal utilizing the internal clock signal. The incoming data stream may particularly be modulated utilizing an Amplitude

Shift Keying (ASK) method and the outgoing data stream may particularly be modulated utilizing a load modulation method or backscattering signaling.

The object is also achieved in accordance with the invention by means of an RFID system, comprising:

a reader which emits a field containing a first data stream and a clock information and the inventive transponder, which is configured to receive the first data stream as the incoming data stream, to decode the first data stream utilizing the internal clock signal, and to generate a second data stream as the outgoing data stream in response to the first data stream.

The inventive method or the inventive RFID system may particularly be advantageous if a plurality of inventive transponders are within the radio range of the reader. An example for such a scenario are relatively closely stacked transponders, as it may be the case when labeling and stacking medication. In such a scenario, the individual transponders may affect each other. In order to achieve a satisfactory performance of such an RFID reader transponder system, particularly to identify each transponder reliably, the energy consumption of each transponder should be kept low. If the plurality of transponders are inventive transponders, or at least some or the majority of these transponders are inventive transponders, then only the transponder responding to the reader, i.e. the transponder transmitting the outgoing data stream weakens the field emitted by the reader. During receiving incoming data streams, the inventive transponders do only little, if at all, weaken the field transmitted by the reader, resulting in a reduced power need for the field transmitted by the reader. The reason why the transponders do hardly, if at all, weaken the field transmitted by the reader during receiving data streams is that they decode these data stream utilizing their internal clock signals.

### BRIEF DESCRIPTION OF THE DRAWINGS

The invention will be described in greater detail hereinafter, by way of non-limiting examples, with reference to the embodiments shown in the drawings.

FIG. 1 is an RFID reader transponder system; and

FIG. 2 is a flow chart illustrating the operation of the RFID reader transponder system.

### DESCRIPTION OF EMBODIMENTS

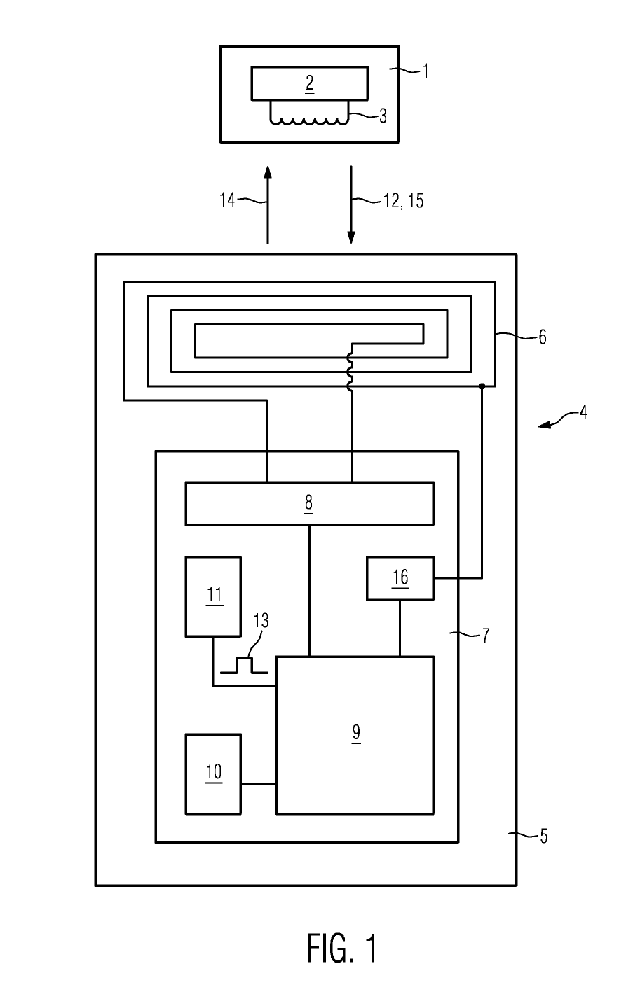

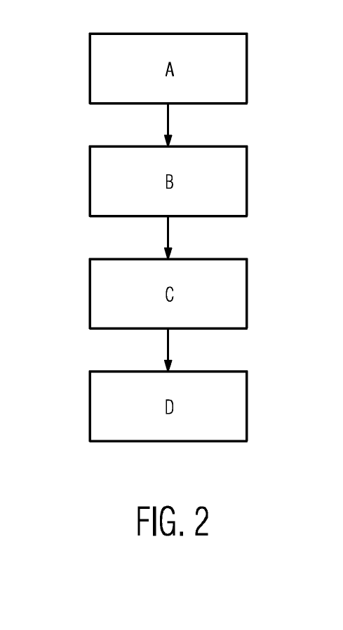

FIG. 1 shows a reader 1 and a transponder 4 and FIG. 2 shows a flow chart illustrating the operation of the reader 1 transponder 4 system of FIG. 1. In this exemplary embodiment, the transponder 4 operates at low or high frequencies less than 30 MHz, such as 125 kHz or 13.56 MHz.

In this embodiment, the reader 1 comprises a central processing unit 2 connected to a reader antenna 3. The transponder 4 comprises a substrate 5, a transponder antenna 6 attached to the substrate 5, and an integrated circuit 7 attached to the substrate 5 and connected to the transponder antenna 6. The integrated circuit 7 is an example for an inventive electronic device and comprises a demodulation/modulation stage 8 connected to the transponder antenna 6, a processing device 9 connected to the demodulation/modulation stage 8, a memory 10 for storing data connected to the processing device 9, and an internal clock signal generator 11. The processing device 9 may, for instance, be a microprocessor or a microcontroller.

The reader 1 and the transponder 4 are configured to communicate with each other. When starting this communication, the reader 1 generates a first data stream 12, which is modulated utilizing an Amplitude Shift Keying method in the exemplary embodiment, and transmits it by means of an electromagnetic or magnetic field (not explicitly shown in the figures) utilizing the reader antenna 3. Furthermore, the reader 1 generates clock information which is also transmitted via the electromagnetic or magnetic field, which is utilized for the first data stream 12.

The transponder 4 receives the first data stream 12 utilizing its transponder antenna 6 (step A of the flow chart of FIG. 2). Upon receiving the first data stream 12, the transponder 4 demodulates the first data stream 12 utilizing the demodulation/modulation stage 8 and processes the demodulated first data stream 12 utilizing the processor device 9. This process is carried out utilizing an internal clock signal 13 generated by the internal clock generator 11 connected to the processing device 9. As a result, the transponder 4 receives, demodulates and processes the first data stream 12 utilizing the clock signal 13. This process is also referred to as an asynchronous transfer mode (step B of the flow chart).

In response to the received, decoded, and processed first data stream 12, the processing device 9 reads data from the memory 10 and generates a second data stream 14. Contrary to the processing of the first data stream 12, the second data stream 14 is not clocked utilizing the internal clock signal 13, but is clocked utilizing the clock information sent by the reader 1 (step C of the flow chart). In this embodiment, the transponder 4 comprises a clock recovery device 16 connected to the transponder antenna 6 and the processing device 9 in order to recover the clock information from the reader 1. Note that the clock information from the reader 1 is also present when the second data stream 14 is sent from the transponder 4 to the reader 1.

While generating the second data stream 14 or after having generated the second data stream 14, the second data stream 14 is modulated utilizing the demodulation/modulation stage 8 and utilizing the clock information from the reader 1. For the exemplary embodiment, the second data stream 14 is modulated utilizing a load modulation method. Then, the second data stream 14 is transmitted from the transponder 4 to the reader 1 utilizing the transponder antenna 6 (step D of the flow chart).

As a result, the first data stream 12 is transferred, decoded, and processed by the transponder 4 utilizing an asynchronous transfer mode and the second data stream 14 transmitted from the transponder 4 to the reader 1 is generated and transmitted based on a synchronous transfer mode utilizing clock information generated by the reader 1 and transmitted to the transponder 4 utilizing the field emitted by the reader 1.

Consequently, the clock recovery device 16 is disabled and the clock generator 11 is enabled while the first data stream 12 is transmitted to the transponder 4 and the clock recovery device 16 is enabled and the clock generator 11 is disabled while the second data stream 14 is transmitted from the transponder 4 in this embodiment.

In one embodiment, the reader 1 can also write data to the memory 10. This is achieved by sending a further data stream 15 from the reader 1 to the transponder 4. The further data stream 15 is also demodulated by the demodulation/modulation stage 8 and processed by the processor device 9 utilizing the internal clock signal 13, and then written to the memory 10, also utilizing the internal clock signal 13.

The RFID system shown in FIG. 1 only comprises one reader 1 and one transponder 4. However, the RFID system can also comprise a plurality of transponders similar to the transponder 4 such that each of the transponders receive the first data stream 12 and decode this data stream 12 utilizing their internal clock signals 13. Then, preferably only the transponder(s) 4 chosen by the reader 1 generate(s) the second data stream 14 utilizing its/their clock recovery device 16.

Finally, it should be noted that the aforementioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The verb “comprise” and its conjugations do not exclude the presence of elements or steps other than those listed in any claim or the specification as a whole. The singular reference of an element does not exclude the plural reference of such elements and vice-versa. In a device claim enumerating several means, several of these means may be embodied by one and the same item of software or hardware. The mere fact that certain measures are recited in mutually different dependent claims does not indicate that a combination of these measures cannot be used to advantage.

1. A method of transmitting data, comprising the steps of:
receiving a first data stream at a low or high frequency transponder via a field emitted by a reader;
decoding said first data stream at said transponder utilizing an internal clock signal generated by said transponder; and
in response to said first data stream, generating a second data stream at and emitting from said transponder to said reader; said second data stream being generated and transmitted utilizing a clock information transmitted via said field emitted by said reader.

2. The method of claim 1, further comprising the step of receiving a third data stream sent by said reader and storing data of said third data stream to a memory utilizing said internal clock signal.

3. The method of claim 1, comprising the step of modulating said first data stream utilizing an Amplitude Shift Keying method and/or modulating said second data stream utilizing load modulation method or backscattering signaling.

4. An electronic device for a low or high frequency transponder, comprising:
an internal clock signal generator for generating an internal clock signal;
a memory for storing data; and
a signal processing device to decode an incoming first data stream utilizing said internal clock signal, to generate an outgoing second data stream in response to said first data stream by reading out said data from said memory, and to clock said second data stream utilizing a clock information contained in a field emitted by a reader.

5. The electronic device of claim 4, configured to store said data in said memory in response to an incoming third data stream utilizing said internal clock signal.

6. The electronic device of claim 4, wherein said first data stream is modulated utilizing an Amplitude Shift Keying method and/or said second data stream is modulated utilizing a load modulation method or backscattering signaling.

7. A low or high frequency transponder comprising:
said electronic device according to claim 4; and
an antenna connected to said electronic device, configured to capture said incoming first data stream via said field emitted by said reader, and to transmit said outgoing second data stream.

8. An RFID system, comprising:
a reader which emits a field containing a first data stream and a clock information; and
said transponder of claim 7, said transponder being configured to receive said incoming first data stream, to decode said first data stream utilizing said internal clock signal, and to generate said outgoing second data stream in response to said first data stream.

9. The RFID system of claim 8, comprising a plurality of said transponders.
